(19) United States
(12) Patent Application Publication
(10) Pub. No.: US 2025/0056375 A1
(43) Pub. Date: Feb. 13, 2025

(54) REACTIVE ROUTING FOR ADVANCED SOFTWARE MODEMS

(71) Applicant: TCT Networks Corporation, Camden, NY (US)

(72) Inventors: Ronny Bull, Frankfort, NY (US); Michael Moore, Clinton, NY (US); John Cook, Little Falls, NY (US); David Cook, Little Falls, NY (US); Scott Burleigh, Los Angeles, CA (US); Joshua Waszkiewicz, Utica, NY (US); Joel Seif, New Hartford, NY (US)

(73) Assignee: TCT Networks Corporation, Camden, NY (US)

(21) Appl. No.: 18/791,523

(22) Filed: Aug. 1, 2024

Related U.S. Application Data
(60) Provisional application No. 63/530,098, filed on Aug. 1, 2023.

(51) Int. Cl. H04W 40/30; H04B 1/00; H04W 40/12

(52) U.S. Cl. CPC H04W 40/30; H04B 1/0003; H04W 40/12

(57) ABSTRACT

An approach for detecting unplanned changes in the link performance of a delay tolerant network and making automatic and immediate adjustments to the contact plans of the network to provide route revisions that will reallocate traffic load to improve network performance. Physical layer information is used to predict link performance and to adapt route computation to avoid disruption and to optimize contact performance. Prediction is based on advanced software defined radio observable phenomena such as signal to noise ratio, background noise measurements, and forward error correction bit error counts. This approach can enable a delay-tolerant network node to recompute routes and revise bundle forwarding decisions automatically in response to changes in the properties of the communication link.

### CROSS-REFERENCE TO RELATED APPLICATIONS

The present application claims priority to U.S. Provisional App. No. 63/530,098, filed on Aug. 1, 2023, hereby incorporated by reference in its entirety.

### BACKGROUND

### 1. Field of the Invention

The present disclosure relates to software modems and, more specifically, to an approach for automatic adjustments to route computations in delay-tolerant networks.

### 2. Description of the Related Art

Platforms suitable for hosting software defined radios (SDRs) are advancing in terms of size, weight and power (SWaP), computational rate and cost. It is currently practical to place forty or more cores of four nanometer logic cells, each core capable of six gigaFLOPS, on a single chip with SRAM and DRAM included. This estimate is based on 1.5 GHz clocking of 4 way Single Instruction Multiple Data (SIMD) floating point units. This level of throughput places gigabit modulation and demodulation within reach of conventional software implementations which, in turn, can provide flexibilities that are impractical for Field Programmable Gate Array (FPGA) implementations. The evolving improvements of on-board SDR hosts gives developers freedom to go beyond essential SDR functions by providing capabilities targeted for autonomous network management. Examples include multiple modulation types, dynamic waveform loading (an SDR's ‘waveform’ is a term referring to the software implementing the radio), measures of link performance, and directional beam control. However, the emergent computational platforms of interest are not yet ready for the space environment. As a result, there is a need in the art for an approach for autonomous optimization of Delay/Disruption Tolerant Networking (DTN) using measures of link performance (LLP) such as Signal to Noise Ratio (SNR), background noise, and Forward Error Correction (FEC) statistics.

### BRIEF SUMMARY OF THE INVENTION

The present invention provides an approach for applying Forward Error Correction (FEC) results, measures of signal to noise level (SNL) and background noise, and other forms of LPP to improve Delay/Disruption Tolerant Networking (DTN) routing by prediction of link performance, referred to herein as Reactive Routing. The present invention may be implemented in space based networks and has been demonstrated in connection with the Interplanetary Overlay Network (ION) DTN. Reactive Routing is preferably implemented in the Bundle Protocol (BP) DTN routing modules at the contact plan level. Reactive Routing utilizes physical layer information to predict link performance, and adapt route computation to avoid disruption and to optimize contact performance. Prediction is based on Advanced Software Defined Radio (ASDR) observable phenomena such as Signal to Noise Ratio (SNR), background noise measurements, and forward error correction (FEC) bit error counts. Reactive Routing will enable a DTN BPv7 node to recompute routes and revise its bundle forwarding decisions automatically in response to changes in the properties of communication links. Reactive Routing will also improve link utilization and reduce throughput loss and management workload in all Delay/Disruption Tolerant Networks (DTN).

In one example embodiment, the present invention is a system for improving routing of software defined radio networks that includes a delay tolerant network having a sender including a first software radio and a receiver including a second software radio that can communicate wirelessly with the first software radio according to a contact plan, a first transmission block module interconnected to the first software radio and programmed to encapsulate a transmit frame with a set of link performance data for wireless transmission by the first software radio, a second transmission block module interconnected to the second software radio and programmed to receive the transmit frame that is encapsulated with the set of link performance data from the first software radio when wirelessly received by the second software radio, and an adapter module programmed to pass the transmit frame that is encapsulated with the set of link performance data from the second transmission block module to a reactive routing module, wherein the reactive routing module is programmed to adjust the contact plan based on the set of link performance data. The reactive routing module may be programmed to adjust the contact plan so that the first software radio will communicate wirelessly with a third software radio instead of the second software radio. The set of link performance data may comprise at least one performance factor selected from the group consisting of a signal to noise ratio, a background noise level, a corrected bit error count, an uncorrected bit error count, a Doppler velocity, and a transmission power level, and a carrier drop count. The reactive routing module may be programmed to determine whether an aggregate bit error rate or an aggregate frame loss rate exceeds a predetermined threshold before adjusting the contact plan. The reactive routing module may be programmed to consider a history of link performance between the first software radio and the second software radio when determining whether to adjust the contact plan. The delay tolerant network comprises an interplanetary overlay network.

In another example, the present invention may be a method of improving routing of software defined radio networks that includes the steps of sending a communication from a first software radio having a first transmission block module interconnected to the first software radio, wherein the first transmission block module encapsulates a transmit frame with a set of link performance data into the communication, wirelessly receiving the communication over a delay tolerant network with a second software receiver having a second transmission block module interconnected to the second software radio that receives the transmit frame encapsulated with the set of link performance data from the first software radio, passing the transmit frame encapsulated with the set of link performance data from the second transmission block module to a reactive routing module, and then adjusting the contact plan with the reactive routing module based on the set of link performance data.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a transmission block that provides the unit of information flow between network stations carried by electromagnetic waves (EMW).

FIG. 2 is a schematic of an ION Reactive Routing stack with adapter and physical layer according to the present invention.

FIG. 3 is a schematic of an exemplary implementation of Reactive Routing in an Interplanetary Overlay Network (IONRR).

FIG. 4 is a schematic of an exemplary format for a transmission black according to the present invention.

FIG. 5 is a schematic of an exemplary metadata block for use in decision making by a Reactive Routing module according to the present invention.

FIG. 6 is a schematic of an emulation environment used to test a system implementing Reactive Routing according to the present invention.

FIG. 7 is a schematic of a CORE Canvas of a 5 Node Earth-Mars Scenario for implementing Reactive Routing in a first step according to the present invention.

FIG. 8 is a schematic of a CORE Canvas of a 5 Node Earth-Mars Scenario for implementing Reactive Routing in a second step according to the present invention.

FIG. 9 is a schematic of a CORE Canvas of a 5 Node Earth-Mars Scenario for implementing Reactive Routing in a third step according to the present invention.

FIG. 10 is a schematic of a CORE Canvas of a 5 Node Earth-Mars Scenario for implementing Reactive Routing in a fourth step according to the present invention.

### DETAILED DESCRIPTION OF THE INVENTION

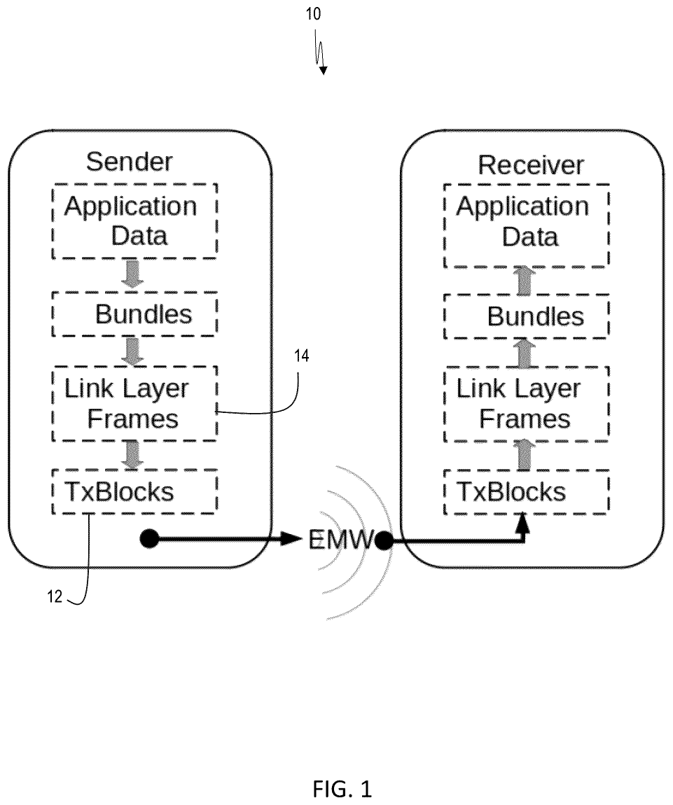

Referring to the figures, wherein like numerals refer to like parts throughout, there is seen in FIG. 1, an exemplary approach according to the present invention, referred to as Reactive Routing 10, that will enable a DTN BPv7 node to recompute routes and revise its bundle forwarding decisions automatically in response to changes in the properties of communication links represented in LPP. Reactive Routing 10 improves link utilization and reduces throughput loss and management workload in all DTNs. These performance improvements are useful for space flight missions including space flight operations mounted by all commercial space businesses and other national space agencies that use DTN for mission communications.

As seen in FIG. 1, Reactive Routing 10 addresses the dependency on physical layer performance information and fulfils a need for managing the control and flow of the information between the physical layer and the link layer. Reactive Routing 10 includes Transmission Block (TxBlock) 12 encapsulating frames 14 as the frames 14 are passed into the physical layer for transmission. Link performance information is sent to other connected nodes to provide network station status information about conditions on the remote ends of links. For example, in a full duplex link, a sender may pass to a receiver signal quality information associated with TxBlocks 12 being received from the receiver's end. The sender can attach its own performance parameters within TxBlock 12. It should be recognized that the amount of information sent in this manner must be limited so as not to absorb significant bandwidth.

The initial set of link performance parameters that may be utilized by Reactive Routing 10 are enumerated in Table I below. Those associated with a receive (Rx) frame are measured at the time of frame arrival. Those associated with a transmit (Tx) frame are likewise tied to conditions at the time of frame transmission, but may be sent within a TxBlock encapsulating the frame for use by a receiver. Transmission power (the setting of the radio frequency emitter's power level) can be transmitted with a frame to inform receivers of the transmission strength. Likewise, background noise, measured at quiescent intervals, can ride along with a transmitted frame. These are ways of informing the stations at the other end of links about conditions. It is the responsibility of the ASM to present locally measured parameters to upper stack layers. The parameters received within TxBlocks continue to ride within the blocks after demodulation, as the blocks are pushed into the next layer of the stack.

TABLE 1
Physical Layer Link Parameters Under Evaluation

| Link Parameter | Related to |
|---|---|
| Signal to Noise Ratio | Measured for Received Frame |
| Background Noise | Measured During Quiet: no Rx, Tx |
| Corrected Bit Error Count | Measured for a Received Frame |
| UnCorrected Bit Error Count | Measured for a Received Frame |
| Doppler Velocity | Derived relative separation rate of change |
| Tx Power Level | Transmitted Frame Set Power Level |
| Carrier Drop Count | Statistics of carrier during contact period |

The locally measured parameters and the parameters of remote ends of links received with incoming frames are potentially useful to overall network operation. Reactive Routing 10 can have access to the entire set, but testing of the present invention with FEC information (bit error information), background noise and SNR were sufficient.

Part of Reactive Routing 10 is the specification of the interactions between Reactive Routing 10 within the DTN layer and the Physical layer (the ASM). A software module designated as the ‘Adapter’ has been identified to be the interface boundary between a link layer protocol implementation and an ASM. Two ‘C’ language Application Program Interfaces (APIs) have been defined for the Adapter. The first is the API the Adapter presents to the Link layer; it is intended to be a device (SDR) independent API. The second is an API to be used by the Adapter to interact with the Physical layer. This is intended to hide all Physical layer device specific characteristics from the Link layer. The intention is to address all such device dependencies within the Adapter. The consequence is that this ‘south-end’ API will need to be customized for the ASM device selected for the space vehicle. This is true whether the ASM is a physical device or an emulation. A prototype Adapter whose Physical layer API matched an emulation of a notional ASM was simply and allowed for implementing RF media using a backnetwork and providing LPP through emulation scripts.

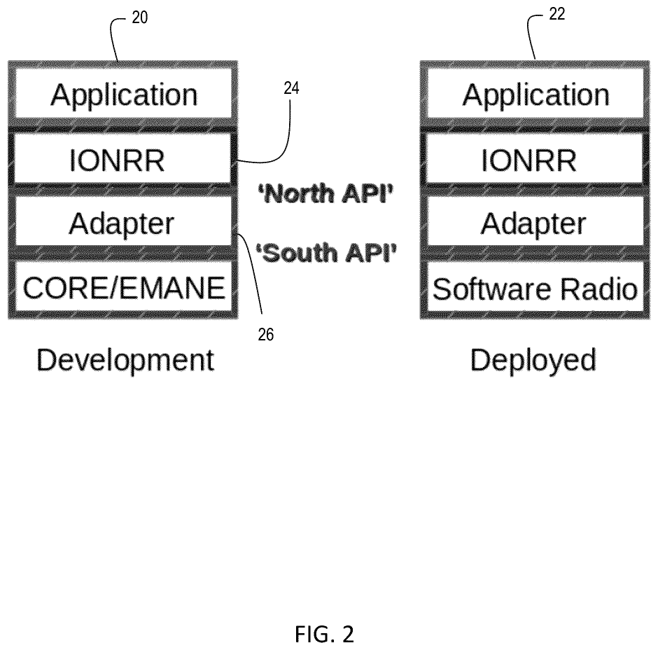

Referring to FIG. 2, an ION Reactive Routing (IONRR) stack is seen in context with the Adapter configured for the RR development emulation environment 20, and for deployment with a physical ASM SDR 22. An ION reactive routing prototype was constructed to enable ION as a mechanism for retrofitting an existing DTN with reactive routing capability. It also readies ION as a mechanism for refining how LPP is supplied. The reactive routing adaptation of ION is called IONRR 24. The initial prototype interacted with an emulated Physical layer through a prototype Adapter 26, and has simple logic for affecting contact graph plans based on one LPP parameter. The PHY Interface Baseline is actually two separate APIs; one ‘north facing’ to the upper layers of the network stack, the other ‘south facing’ to the physical layer. As seen in FIG. 2, the Adapter's “north” boundary meets the layers of the DTN (ION in this illustration) and its “south” boundary meets the physical layer. South facing API is to be customized to interact with different SDR implementations. In this example, the SDR is a notional emulated radio functionally representative of an anticipated technology. The customization is targeted to our EMANE emulation. Standardization of the SDR side API should be given consideration for the sake of cost efficiencies related to open system standards.

The ‘north side’ API of the Adapter is likewise an opportunity for standardization cost efficiency. It provides a device-independent view of the SDR to the network layers. The ‘upper’ or north-side API provides data and control planes in the form of functions, and other functions for acquiring PHY Layer performance parameters. Data frames destined for a remote node (frames destined to be modulated then transmitted) are sent into the interface by the DTN using a function call. Frames arriving from a remote node and destined for the local DTN are sent to it by the interface using a callback function defined by the DTN side. The control plane is provisioned the same way, and can be used for controlling the SDR. Parameters needed by Reactive Routing are passed up the network stack to the DTN layers in a metadata block attached to incoming frames by the interface.

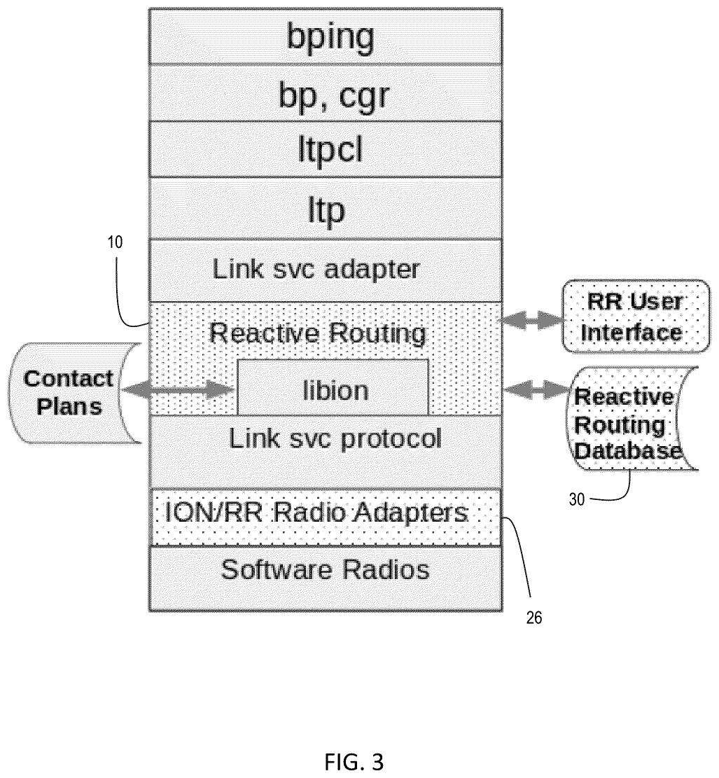

Referring to FIG. 3, a prototype IONRR was constructed from ION. IONRR includes a new user interface for configuring Reactive Routing 10 by means of changes to a reactive routing database 30 in shared memory. Dotted areas represent modules unique to IONRR, while solid areas are unchanged ION modules. The Adapter module 26 (labeled as ION/RR Radio Adapters) links to ION modules during the build process. IONRR augments the ION open-source baseline in two ways. For the IONRR prototype, ION was configured to use the Licklider Transmission Protocol (LTP) at the “convergence layer” below the Bundle Protocol, enabling reliable transmission over long signal propagation distances. The Consultative Committee for Space Data Systems (CCSDS) Advanced Orbiting Systems (AOS) Link Protocol was selected for the IONRR prototype because it is supported by open-source ION. A new IONRR link service adapter (LSA) was added for use by LTP, wrapping LTP segments in CCSDS “encapsulation packets,” which in turn are encapsulated in AOS frames. AOS frames are passed to the Adapter, over the Adapter's north-facing API, for physical transmission. On reception, the received frames are passed from the Adapter back up to the Encap/AOS LSA along with current link performance information. The Encap/AOS LSA passes the encapsulated segments up to LTP and conveys the link performance information to the Reactive Routing module.

When implemented, Reactive Routing 10 begins with DTN bundles forwarded to their destinations according to routes computed from time-varying network topology as asserted in contact plans; this is “contact graph routing” (CGR). The intent of CGR is to maximize network throughput by delivering bundles to their destinations as soon as possible, for this purpose, high-rate transmission links are preferred to slower links. Next, upon the transponder's reception of a data frame and delivery to the bundle protocol agent, link operational metadata is delivered along with the data. That metadata is passed to Reactive Routing 10 module, which uses it to detect changes in the character of the link. When those changes indicate degraded performance, Reactive Routing 10 infers a reduction in the data rate of the link; the revised data rate is applied to the contact plan. Reducing the data rate of a link makes it less preferred. CGR responds by revising routes, causing bundles to travel over routes that are not degraded, thus preserving high throughput.

Link performance degradation may be detected and a revised data rate computed by using an ‘rradmin’ utility is used to configure thresholds for bit error rate and frame loss rate. All link metadata received in the course of any single second is then collected in a single “sample”. Once per N seconds, the total numbers of bits received, corrected and uncorrected bit errors, and frames received with and without uncorrected bit errors are summed over the preceding M samples, where N and M are additional configuration parameters. If either aggregate bit error rate or aggregate frame loss rate exceeds its configured threshold, the link's effective data rate is reduced by 25%. Otherwise (rates are below thresholds; performance has recovered): the link's effective data rate is increased by 50% of the difference between the most recent adjusted data rate and the rate that was originally administratively asserted in the contact plan.

This embodiment of Reactive Routing 10 is simple and intended for the ‘shakeout’ of IONRR, the Adapter and the emulation environment in which it operates. Reactive Routing 10 computes moving averages of bit error rate and frame loss rate for the link to the peer DTN node from which link performance information is received. Locally detected variations in link performance are assumed to indicate link impairments that are symmetrical, affecting transmissions both to and from the peer node. On this basis, any change in those averages that exceeds a configured threshold causes the local node's current transmission rate to the peer node to be adjusted by a configured increment. Such an adjustment may degrade or even disable routes that include the affected link; ION's Contact Graph Routing algorithms, which are informed by the data rates supported by current and planned episodes of link activity, respond to the transmission rate change by revising routes and redirecting bundles to routes that have thereby become more favorable.

The Adapter is responsible for pushing received frames into the Link layer, and associating LPP with each frame as they are pushed. The Adapter does this by selecting and combining components of LPP parsed from the incoming TxBlock and locally produced LPP.

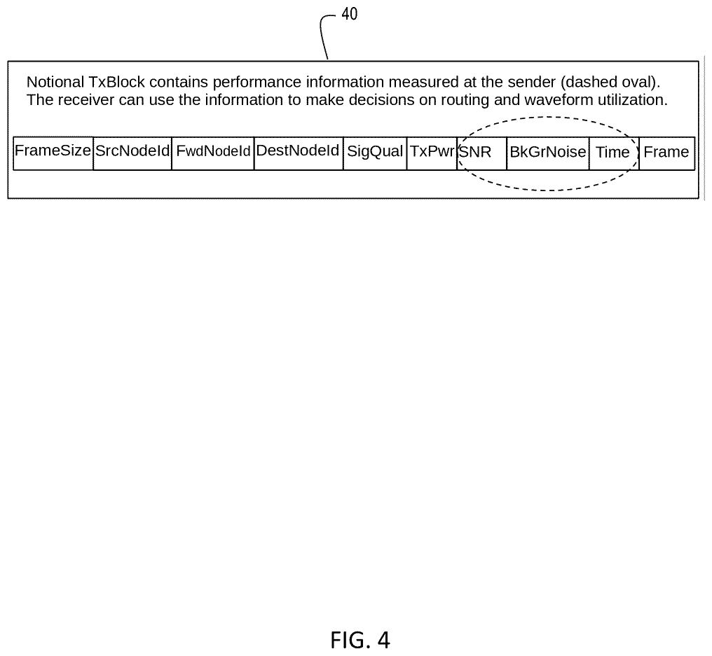

Referring to FIG. 4, an exemplary TxBlock model 40 used for IONRR is shown. The gray oval shading covers four fields used for passing some of a Sender's LPP information to a Receiver. Note that Frame, in this case AOS, rides in the block to the right of the gray oval. The fields on the left side (Frame Size, Source Nodeld, FwdNodeld and Dest Nodeld) are not necessary for Reactive Routing 10. The four LPP components are: Signal Quality, Tx Power, Signal to Noise Ratio and Background Noise. All but the Signal Quality field align to previously mentioned performance parameters. The Signal Quality field is an optional provision for communicating an over-all representation of how well recent messages arriving at the Sender, from the receiver, are perceived and may be used as a predictor or an expectation of future performance.

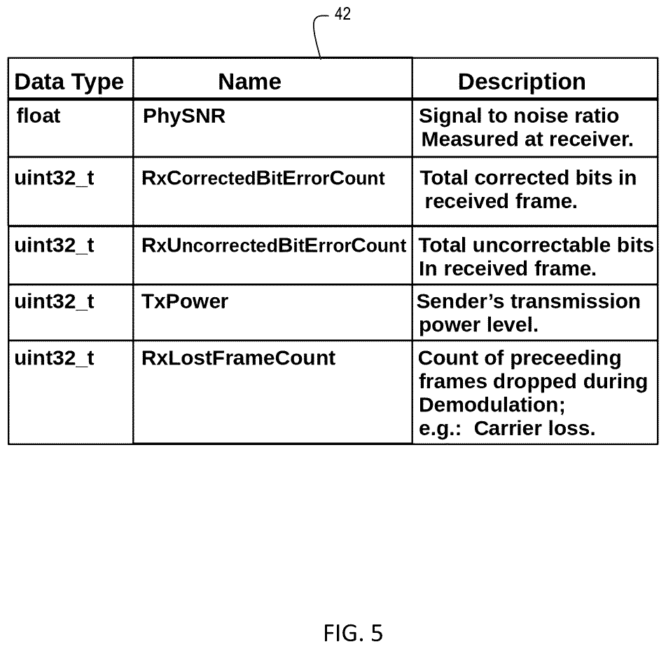

A receiver of a TxBlock parses the LPP and the frame, and also collects the locally measured LPP. The Adapter keeps a history of the Sender and local LPP. At any time the Adapter will supply upper layers with the history information via the North API. However, information from the history that is associated with the received frame is sent with the frame as a metadata block, as the frame is pushed to the Link layer. The metadata is what Reactive Routing 10 primarily uses for decision making. An exemplary metadata block 42 is illustrated in FIG. 5.

Reactive Routing 10 reacts to the metadata accompanying each frame, but can also utilize link histories of LPP to predict how frame reception will continue during the contact period. Machine learning algorithms can be trained on link histories while a station is operating in a network, and its reactions are not confined to transmission rate adjustments. Reactive Routing 10 is configured to send control and status information through the network to revise its own and other station contact plans. It will have access to ASM controls, managed by a resource manager that orchestrates reactions of other advanced capabilities such as topology managers and cognitive radio functions, to alter Link Protocols, modulation types, carrier frequencies, transmission power, FEC usage and antenna characteristics.

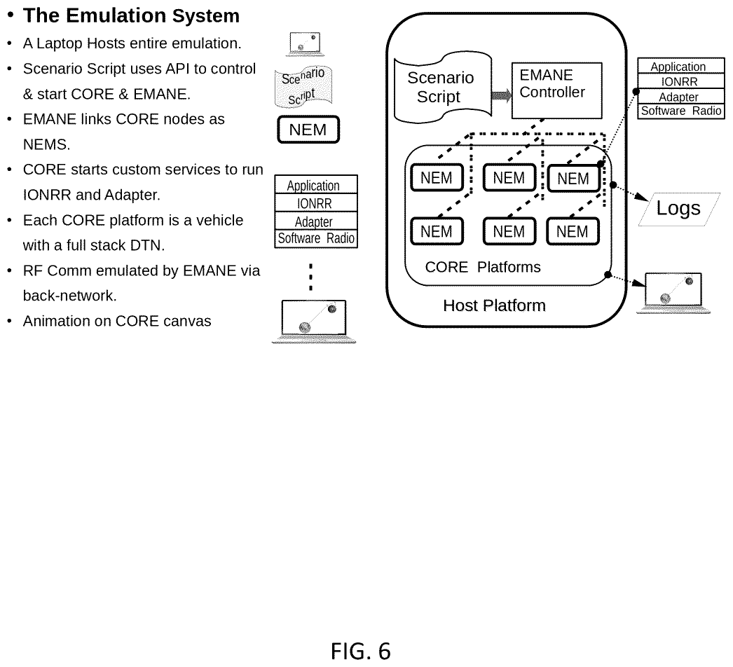

The exemplary implementation is a simple system intended to provide basic DTN scenarios, such as those for Earth-Mars and Cislunar environments. An EMANE scenario script was created to demonstrate an Earth-Mars DTN scenario involving a Mars surface station (endpoint), two relays in Mars orbit, an Earth Deep Space Network (DSN) station and an Earth operations center (end-point). The script was successfully executed on an emulation environment as seen in FIG. 6 to demonstrate IONRR-Adapter prototypes operate as expected. The SDR models and visualization may be enhanced to enable IONRR to be predictive. The current set of LPP parameters may also be investigated to identify additional parameters with potential for RR utilization.

The five-node scenario emulation was executed in ‘faster than real-time’ to eliminate long waits for test run results. While emulated time was managed to represent real-time (from the network perspective), the wait intervals between emulation steps were reduced where no model computation was being performed. The result was that hours long scenarios were executed in a few minutes. Five virtual node emulations executed seamlessly on an Ubuntu platform. The testing indicated that a modern multi-core X86-64 laptop would be able to run scenarios with significantly more CORE virtual nodes.

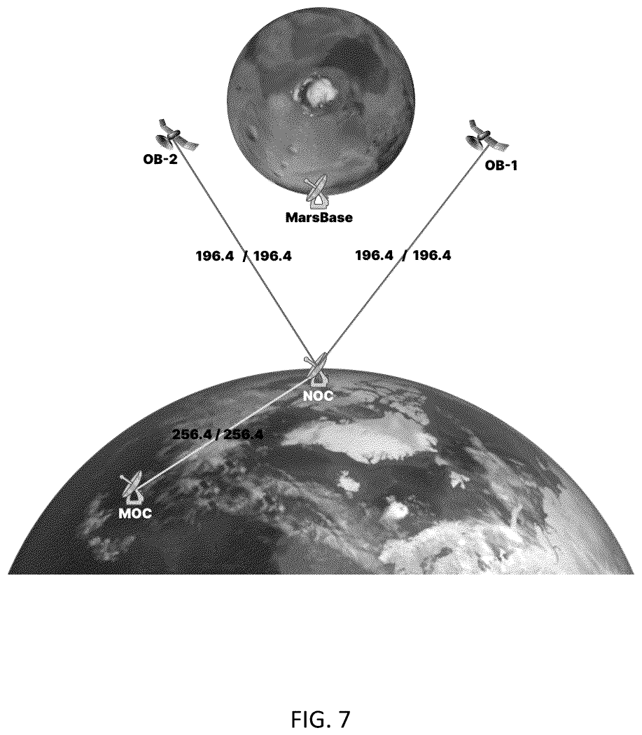

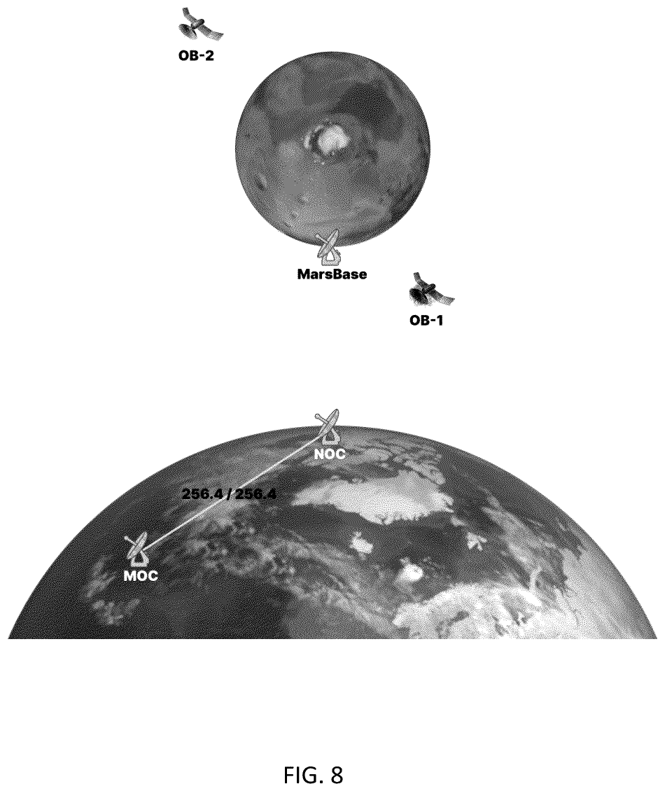

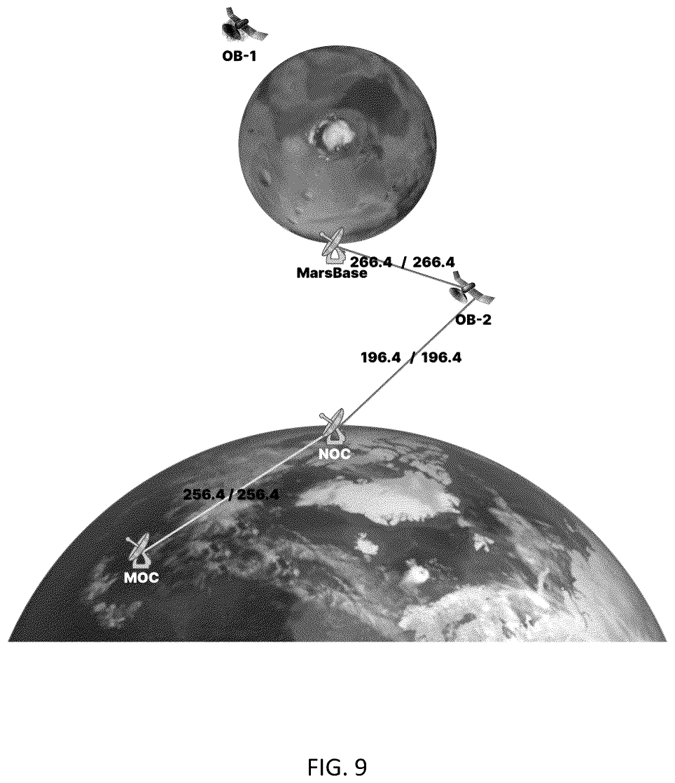

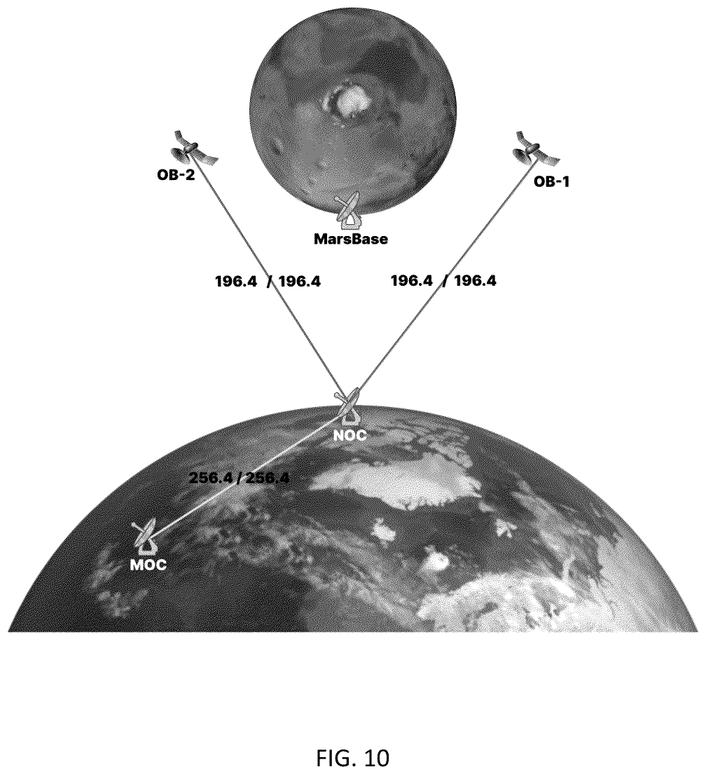

FIGS. 7-10 illustrate the operation of Reactive Routing 10 in an exemplary scenario. In the scene depicted in FIG. 7, communication links are established between the orbiters (OB-X), ‘OB-1’ and ‘OB-2’, and the Network Operating Center (NOC). The flow of data travels from the Mission Operating Center (MOC) to the ‘NOC’ and distributed to both Mars orbiters. Any data destined for the ‘MarsBase’ is being stored due to the nature of Delay Tolerant Networking. This figure depicts the ideal state of the networked environment. During normal operations, as seen in FIG. 8, ‘OB-1’ suffered damage and can no longer maintain its link with the ‘NOC’. Furthermore, ‘OB-2’ is out of range, and cannot ‘see’ the ‘NOC’. Due to the loss of ‘OB-1’ and its storage, ‘OB-2’ will have to dynamically take on the role of ‘OB-1’ and forward information as needed. As seen in FIG. 9, once ‘OB-2’ returns into sight of the ‘NOC’, it will ingress data originally destined for ‘OB-1’ and egress it to the ‘MarsBase’ as needed. It will continue through this process until ‘OB-1’ has returned from its inactive state. Finally, as seen in FIG. 10, following ‘OB-1’s repair, the ‘NOC’ re-establishes communication with both orbiters and returns to the ideal network environment.

What is claimed is:

1. A system for improving routing of software defined radio networks, comprising:
a delay tolerant network having a sender including a first software radio and a receiver including a second software radio that can communicate wirelessly with the first software radio according to a contact plan;
a first transmission block module interconnected to the first software radio and programmed to encapsulate a transmit frame with a set of link performance data for wireless transmission by the first software radio;
a second transmission block module interconnected to the second software radio and programmed to receive the transmit frame that is encapsulated with the set of link performance data from the first software radio when wirelessly received by the second software radio; and
an adapter module programmed to pass the transmit frame that is encapsulated with the set of link performance data from the second transmission block module to a reactive routing module, wherein the reactive routing module is programmed to adjust the contact plan based on the set of link performance data.

2. The system of claim 1, wherein the reactive routing module is programmed to adjust the contact plan so that the first software radio will communicate wirelessly with a third software radio instead of the second software radio.

3. The system of claim 2, wherein the set of link performance data comprises at least one performance factor selected from the group consisting of a signal to noise ratio, a background noise level, a corrected bit error count, an uncorrected bit error count, a Doppler velocity, and a transmission power level, and a carrier drop count.

4. The system of claim 3, wherein the reactive routing module is programmed to determine whether an aggregate bit error rate or an aggregate frame loss rate exceeds a predetermined threshold before adjusting the contact plan.

5. The system of claim 4, wherein the reactive routing module is programmed to consider a history of link performance between the first software radio and the second software radio when determining whether to adjust the contact plan.

6. The system of claim 5, wherein the delay tolerant network comprises an interplanetary overlay network.

7. A method of improving routing of software defined radio networks, comprising the steps of:
sending a communication from a first software radio having a first transmission block module interconnected to the first software radio, wherein the first transmission block module encapsulates a transmit frame with a set of link performance data into the communication;
wirelessly receiving the communication over a delay tolerant network according to a contact plan with a second software receiver having a second transmission block module interconnected to a second software radio that receives the transmit frame encapsulated with the set of link performance data from the first software radio;
passing the transmit frame encapsulated with the set of link performance data from the second transmission block module to a reactive routing module; and
adjusting the contact plan with the reactive routing module based on the set of link performance data.

8. The method of claim 7, wherein the step of adjusting the contact plan comprises causing the first software radio to communicate wirelessly with a third software radio instead of the second software radio.

9. The method of claim 8, wherein the set of link performance data comprises at least one performance factor selected from the group consisting of a signal to noise ratio, a background noise level, a corrected bit error count, an uncorrected bit error count, a Doppler velocity, and a transmission power level, and a carrier drop count.

10. The method of claim 9, wherein the reactive routing module determines whether an aggregate bit error rate or an aggregate frame loss rate exceeds a predetermined threshold before adjusting the contact plan.

11. The method of claim 10, further comprising considering a history of link performance between the first software radio and the second software radio when adjusting the contact plan.

12. The method of claim 11, wherein the delay tolerant network comprises an interplanetary overlay network.
